(19) United States
(12) Patent Application Publication
(10) Pub. No.: US 2015/0135268 A1
(43) Pub. Date: May 14, 2015

(54) SYSTEM AND METHOD TO IMPROVE NETWORK SECURITY

(71) Applicant: MULTINNOVATION, INC., Sunnyvale, CA (US)

(72) Inventor: Shmuel Silverman, Sunnyvale, CA (US)

(73) Assignee: MULTINNOVATION, INC., Sunnyvale, CA (US)

(21) Appl. No.: 14/080,613

(22) Filed: Nov. 14, 2013

(51) Int. Cl. H04L 29/06

(52) U.S. Cl. CPC H04L 63/08
USPC 726/3

(57) ABSTRACT

Embodiments of the present invention enable an organization's system to disavow false network load/traffic from overwhelming its servers. The system includes a processor, and a memory having instructions executable by the processor to determine load on its network. If the load on the network is more than a considerable limit then the system may enable shadow servers to move to a new but randomly selected location by replicating its current state and data to the new location. Additionally, the legitimate clients may always be updated about the new location of the shadow server. This may allow the legitimate clients of the system to follow the shadow server and enjoy the services. However, the illegal clients may not be able to predict the new location of the shadow server and thus may not harm their targeted set of services.

### FIELD OF THE INVENTION

The invention relates to security enhancements in the networks. More specifically, the invention relates to a technique for resisting networks against denial-of-service attacks.

More so, the invention relates to dynamic network topology that adjust itself based on learning of external and internal constrains and ‘life optimized’ algorithms.

### BACKGROUND OF THE INVENTION

With the increase in the globalization, many industries are trying to exploit potential hidden in the Internet. These industries are attracting customers by offering their products and services online, as internet is a fast, convenient and cheaper method to reach to worldwide audience. However, Internet has its own set of deficiencies. For example, as every server that provides services and is connected to the Internet is by default exposed to the world by its address (physical as well as logical). Therefore, any attacker may attack on the server's address (in many ways) and may disrupt the services provided by the server. One of such well known attack is known as ‘Denial of service’ attacks or DOS attacks.

In case of denial of service (DOS) attack on an organization (web service of organization), the organization is deprived of the services it provides to its customers. These kinds of attacks are not new but it is necessary to take preventive measures against them. These attacks can result in significant loss of resources, money, time, and reputation of the associated organization. The basic concept of the DOS attack is to target a server of an organization (that provides services to clients) with enormous false requests. These false requests make the server too busy in their handling that the requests from the organization's legitimate clients get ignored by the server. Therefore, the actual purpose of the server to provide services to its customers, gets diminished and the server just wastes time, recourses, and money in handling the malicious requests.

There are many ways available to block the denial of service attacks. One of such way is to detect the attack and report it. Thereafter try to block the attack by sending all the traffic to an inactive server that rejects all the traffic. This technique is not of much use as this technique does not recover legitimate clients out of the malicious/false clients. Another technique to block the attack is steering the load to other valid servers that can analyze the traffic and can reject the false/malicious requests. This technique is not very efficient as the servers cannot scan all false/malicious requests and hence are not of much help. Further, this technique does not provide a feasible solution as the number of servers, required to handle DOS attacks, is very large.

However, there is one technique that is commonly used against the denial of service attacks and is known as firewall technique. In this technique, a filter is setup on a network that can scan all the traffic reaching to the network. The filter can scan the traffic coming to the network and may recognize repetitive patterns or identifiers in the traffic. Thereafter, the filter may deny all the data packets containing such patterns or identifiers to reach to the network. This technique can remove a lot of false load from the servers but it can also be compromised and hence is not efficient enough.

Based on the aforementioned, there is a need for a system and a corresponding method that can allow an organization to completely prevent its servers from ‘denial of service’ attacks. Furthermore, the system and the corresponding method should not reject requests made by legitimate clients. The system and the corresponding method should be efficient enough to handle complex and large scale network attacks in order to ensure network security and reliability.

### SUMMARY

In an embodiment of the present invention, a system for improving security and thereby performance in a network is disclosed. The system may have a plurality of entities therein. The system comprises of a processor and memory. The memory may include, but is not restricted to, one or more instructions executable by the processor to provide a network topology corresponding to an active shadow server to a valid entity of the plurality of entities. The network topology may be provided to enable the valid entity to establish communication with the shadow server present at a first location. Further, an address of the shadow server is changed from the first location to a second location based on one or more criteria. The second location may be unknown to the plurality of entities of the network.

Hereinabove, the address of the shadow server may be changed after informing the valid entity regarding the second location of the shadow server. The valid entity may be informed regarding the second location of the shadow server to enable the communication between the valid entity and the shadow server present at the second location.

In another embodiment of the present invention, a communication network is provided. The communication network may include a plurality of shadow servers. Further, each of the shadow servers may have a first location assigned thereto, the first location may be provided to one or more valid clients for enabling the valid clients to communicate with the shadow server. Herein, the first location of each of the shadow servers changes to a secret second location based on one or more criteria. The first location may change to the secret second location subsequent to sharing the secret second location with the valid clients of the shadow server.

In yet another embodiment of the present invention, a method for maintaining network security is provided. The method includes determining a distance between a shadow server and one or more other shadow servers to detect proximity there between. The method further includes maintaining a safe logical address distance, between the shadow server and the one or more other shadow servers, by changing an address of the shadow server from a first location to a second location when the proximity between the shadow server and the one or more other shadow servers crosses a threshold level. Here, the shadow server may be enabled to inform one or more valid clients, associated with the shadow server, regarding the second location prior to changing the address of the shadow server from the first location to the second location.

Herein, the safe logical address distance corresponds to a distance between the shadow server and the one or more other shadow servers that is necessary to be maintained for a secure communication between the shadow server and the valid clients (valid entities), as well as, for maintaining overall optimal performance in providing services.

### BRIEF DESCRIPTION OF THE DRAWINGS

Having thus described the invention in general terms, reference will now be made to the accompanying drawings, which are not necessarily drawn to scale, and wherein

FIG. 1 illustrates an exemplary environment where various embodiments of the present invention are implemented;

FIG. 2 illustrates a block diagram of a system for providing services to one or more of its clients, in accordance with an embodiment of the invention;

FIG. 3 illustrates another exemplary environment where various embodiments of the present invention are implemented;

FIG. 4 illustrates yet another exemplary environment where various embodiments of the present invention are implemented;

FIG. 5 illustrates still another environment where various embodiments of the present invention may be implemented;

FIG. 6 illustrates a communication structure between a client and a shadow server, in accordance with an embodiment of the invention;

FIG. 7 illustrates structure of the shadow server's migration topology, in accordance with an embodiment of the invention;

FIG. 8 (FIGS. 8A and 8B) illustrates a flow diagram of a method for enabling a server present at first location in the network to migrate to second location in the network, in accordance with an embodiment of the invention;

FIG. 9 illustrates a flow diagram of a method for enabling a client to communicate with one or more shadow servers even after changing its address, in accordance with an embodiment of the invention; and

FIG. 10 (FIGS. 10A and 10B) illustrates a flow diagram of a method for enabling a beacon server to restrict a shadow server from changing its location, in accordance with an embodiment of the invention.

### DETAILED DESCRIPTION OF THE INVENTION

Illustrative embodiments of the invention will now be described more fully hereinafter with reference to the accompanying drawings, in which some, but not all embodiments of the invention are shown. The invention may be embodied in many different forms and should not be construed as limited to the embodiments set forth herein; rather, these embodiments are provided so that this disclosure will satisfy applicable legal requirements. Like numbers refer to like elements throughout.

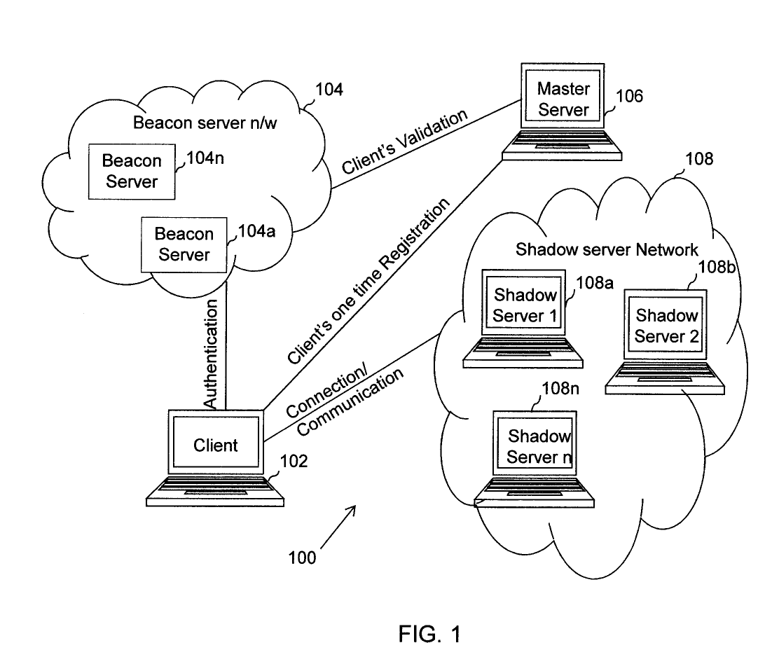

FIG. 1 illustrates an exemplary environment 100 where various embodiments of the present invention are implemented. Further, FIG. 1 illustrates the environment 100 for providing network related services to plurality of entities (hereinafter, may be referred to as “clients”), in accordance with an embodiment of the invention. The environment 100 includes a client 102 that is in communication with a beacon server network 104. In an embodiment, the environment 100 may include more than one client. Further, the beacon server network 104 may include ‘n’ number of beacon servers, such as beacon server 104a (as shown). Furthermore, every beacon server may be pre-allocated to a specific client by a master server 106 for the purpose of authentication (of the client). For example, the beacon server 104a may be pre-allocated to the client 102 for authentication. In an embodiment, one beacon server may be allocated to more than one client. In another embodiment, more than one beacon servers may be allocated to a single client.

Initially, a new client may be facilitated to register itself by providing certain information that may be required for registration. The master server 106 may then store the registration information (provided by the client itself) of the new client that may be utilized (by a beacon server) to verify the client when the client tries to access the network. The client may connect to the beacon server that may be configured to authenticate the client based on the registration data available with the master server 106. Further, after authentication, the beacon server may provide the client with information required to contact a shadow server (present in a shadow server network 108) and thereby may enable the client to access the required services by communicating with the shadow server. The shadow server network 108 may include one or more shadow servers, such as, shadow servers 108a, 108b . . . 108n. Every beacon server (of the beacon server network 104) may have contact information corresponding to one or more than one shadow servers. The contact information may correspond to, but not restricted to, current network/physical address of shadow servers in the shadow server network 108.

Further, the shadow servers present in the shadow server network 108 may be configured (by using a ‘life’ algorithm) to change their physical address by coping or moving its state and data into another server that is present at a different location (but within the shadow server network 108). In an embodiment, the shadow network 108 and beacon server network 104 represents Internet or World Wide Web. In addition, the shadow servers may also change their logical address (IP address). In an embodiment, the shadow servers may be configured to change either or both of their physical or logical address. In an embodiment, the beacon servers and the clients may also be provided with the life algorithm to continuously change either or both of their physical (geographical location) as well as logical (IP address) locations. Such change in the location of the beacon servers prevents any malicious client from attacking the beacon servers.

Furthermore, a shadow server may depend on its ‘life’ algorithm to determine a new server that is present at a different location to move its state and data. The purpose of the life algorithm may be to maintain randomness in the physical address of its shadow server. Additionally, the life algorithm may also make sure that no two shadow servers can come close in distance with each other, i.e. that no two shadow servers copies or move themselves to other servers that are present in a same subnet or are present in proximate location with each other. In case, two shadow servers copy or move themselves to servers present in proximate location with each other or in the same subnet, their life algorithms may instruct them to move again to some other servers present in different locations or in different subnets (sub-networks). This may prevent excessive loading of a network (having more than one shadow servers) with the requests to access the shadow servers. In an embodiment, all shadow servers may be aware of each other's physical or logical locations.

In an exemplary embodiment of the invention, the client 102 may register its details with the master server 106 to avail a particular service. The master server 106 may create a profile of the client where all data concerning to the client 102 can be stored. Thereafter, the master server 106 may determine an existing shadow server (such as shadow server 108a) or create a new shadow server that can provide services to the client 102 as required. In an embodiment, the master server 106 may allocate more than one shadow server to the client 102 in order to make sure that if one or two shadow servers are attacked (with false requests), even then the service should be available to its legitimate clients.

Further, in an embodiment of the invention, similar to the shadow servers, the beacon server may also possess the life algorithm as present with the shadow servers. Therefore, the beacon server may be able to predict (from the life algorithm) location of a shadow server in the shadow server network 108 at a given time period. Based on the aforementioned, the beacon server may be able to update a legitimate (authenticated) client corresponding to location of the shadow server without being in communication with any shadow server in the shadow server network 108. In still another embodiment, the beacon server may be used only for the purpose of authenticating a client and to update the client (after authentication) with the life algorithm (as possessed by the shadow servers). The clients may then use the life algorithm to predict current location of a required shadow server in the shadow server network 108. Therefore, after authentication, the clients may not be required to be in communication with the beacon server. Though, in case, if the client loses track of the shadow server, then the client may re-authenticate itself from the beacon server to again receive the life algorithm possessed by the shadow servers as well as beacon servers.

In another embodiment, the master server 106 may allocate a beacon server (such as beacon server 104a) to the client 102. The beacon server 104a may be configured to remain updated of the present topology of the network. In an embodiment, the beacon server 104a may be always updated with the present physical as well as logical addresses of the shadow server 108a. In an embodiment of the invention, the shadow server 108a can change its physical or logical address only with the consent of the beacon server 104a. Therefore, the beacon server 104a may always remain aware of the location of the shadow server 108a on the shadow server network 108. In an embodiment, the beacon server 104a may be aware of the full shadow server topology. In another embodiment, the beacon server 104a may be aware of the full client-server topology (including other beacon servers and shadow servers).

Further, in order to request service, the client 102 may contact its allocated beacon server 104a that is present in the beacon server network 104 to know the contact details (physical or logical address) of the shadow server 108a. In response, the beacon server 104a may ask the client 102 for authentication. The client 102 may then provide predetermined credentials (predetermined with the master server 106 during registration) such as login ID and password to the beacon server 104a. The beacon server 104a may then authenticate the client (valid entity) by checking the authenticity of the credentials provided by the client 102 and may accordingly allow or deny the client 102 from further proceedings. In case, if the client 102 gets authenticated, the beacon server 104a may provide the client with the complete topology details (including the contact details of the shadow server 108a) to access the services offered/provided by the shadow server 108a.

During the time when the client 102 is in communication with the shadow server 108a, if the life algorithm (hereinafter, may also be referred to as random life algorithm) of the shadow server 108a decides to move the location of the shadow server 108a to a new (but random) location (or to change physical or logical address of the shadow server 108a) then the shadow server 108a may first inform the beacon server 104a of such decision. The beacon server 104a may then decide whether or not to allow the shadow server 108a to move to a new location. In case, if the beacon server 104a does not allow the shadow server 108a to move to a new location, then the client 102 may continue its communication with the shadow server 108a. In another case, if the beacon server 104a allows the shadow server 108a to move then the shadow server 108a may first replicate itself to a new location (copy its state and data into another server via Internet) and then inform the client 102 (via suitable means) corresponding to its availability at new location after a particular timestamp. After the particular timestamp, the old node of the server may be deleted and the service offered by the shadow server 108a may only be available from the address of its new node.

Further, if the client 102 does not receive the information corresponding to the shift of the shadow server 108a to a new location due to slow connection or any other issue, then the client 102 may again contact the beacon server 104a to request the new position of the shadow server 108a. The beacon server may again verify the client 102 and may provide the client the updated client server topology. In this way, the legitimate clients may always remain in communication with the shadow servers and the false (illegal) clients may never be able to predict the location of the shadow servers and therefore the shadow servers may never be victim of the service denial attacks. This will improve the efficiency and reliability of the services being provided on a network, such as Internet.

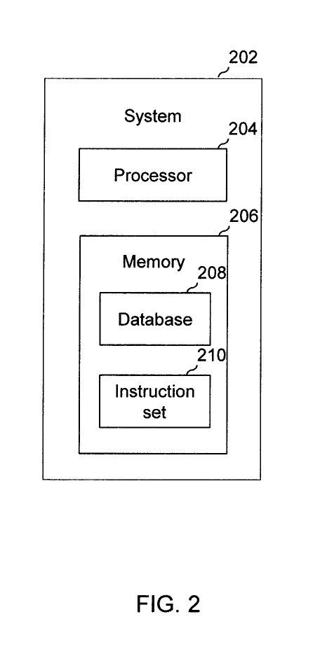

FIG. 2 illustrates a block diagram of a system 202 for improving security of a network while providing services to one or more of its clients, in accordance with an embodiment of the invention. In an embodiment, the system 202 may be implemented by utilizing a group of shadow servers (unaware of locations of each other) aimed to collectively provide a particular network service to clients in a secured manner. In another embodiment, the system 202 may be implemented as a shadow server 108a. In still another embodiment, the system 202 may be implemented as a part of the shadow server 108a. For the better understanding of the invention, the system may be considered as a part of the shadow server 108a. Moreover, the system 202 may be utilized by other servers, such as beacon servers for communicating with clients in a secured and reliable manner.

Further, the system 202 may include a processor 204 and a memory 206. The memory 206 may include a database 208 and an instruction set 210. The database 208 may include specific type of data that is required to support provision of the aforementioned ‘particular service’ to its clients. For example, the system 202 may be implemented to provide services corresponding to an online buying and selling website. So, all the data that is required to support the online buying and selling website may be stored in the database 208 of the system 202.

Furthermore, the database 208 may include details corresponding to the beacon servers present in the beacon server network 104. The details corresponding to the beacon servers may enable the system 202 to differentiate between a legal and an illegal (false) beacon server in order to ensure receiving instructions from legal beacon servers only. Again further, the database 208 may also include a list of clients that the system 202 (or the shadow server implementing the system 202) is required to serve (with the services required by the clients). In an embodiment, one or more of the beacon servers may provide the system 202 with the list of clients to communicate.

Further, the instruction set 210 of the memory 206 may include instructions executable by the processor 204 to receive requests from clients, and to process them as required by the clients. Further, the instruction set 210 may include instructions executable by the processor to monitor number of requests received per unit time (monitoring load on its network) by the shadow server. In case, the requests received per unit time by the shadow server is equal or above than a considerable limit then the instructions executable by the processor 204 may instruct the shadow server to move to a new location by replicating its state and data into another randomly selected server, based on a random life algorithm.

In an embodiment, the random life algorithm may be designed to control the life cycle of the shadow server. Further, the random life algorithm may be configured to move the physical or logical (or both) location of the shadow server from a first location to a second/new location. In an exemplary embodiment, the random life algorithm must determine the second location randomly. In an embodiment, migration of the shadow server from the first location to the second location may include copying/transferring the shadow server's present state and data from the first location to the second location, and by activating the shadow server at the second location and also by deactivating the shadow server from its first location.

Furthermore, based on one or more criteria, the random life algorithm may decide whether the shadow server is required to migrate to the randomly selected second location or not. In an embodiment, migration of the shadow server may include changing the address of the shadow server from one location to another location. The one or more criteria may include, but not restricted to, increase in proximity of the shadow server with one or more other shadow servers in the network beyond a threshold level, overloading of the shadow server with the requests from authenticated and illegal clients/entities, and a set of random parameters such as date and time that changes constantly. Such Migration may prevent the shadow server from dealing with the malicious requests from illegal clients and thus may ensure better services for the legitimate clients. The randomness in the migration process may be aimed to get rid of all those clients that are not validated by the beacon server. Only the valid-clients can have access to the updated locations of the shadow servers with the help of the life algorithm shared by the beacon server. This may facilitate the valid clients to enjoy services seamlessly and may prevent the illegal clients from accessing the services.

In an embodiment, the instructions executable by the processor 204 may enable the shadow server to seek confirmation from one or more of its allocated beacon servers for changing its location. If the beacon server allows, then the system 202 may enable the shadow server to migrate (from one location to another location) subsequent to informing the valid/legal clients/entities (by sending a message (via suitable means) to the list of all legal clients) regarding the availability of the services from a new (second) network address after a particular timestamp. In another embodiment, the system 202 may enable the shadow server to migrate to a new location without requiring any confirmation from one or more beacon servers and without even informing the beacon servers corresponding to its new location. The beacon servers may possess a similar life algorithm as possessed by the shadow servers. The beacon servers may therefore be able to predict the location of any shadow server at a particular timestamp by using the life algorithm.

Further, in order to migrate to a new location, the system may enable the shadow server to replicate itself (i.e., its state and data) to a new (random) location and may delete its state and data from the old location. The legal clients may then communicate with the shadow server at the shadow server's new/second location. On the other hand, if the beacon(s) server does not allow the shadow server to move to the randomly selected location, then the shadow server may continue providing services to its connected clients. In an embodiment, the shadow server may retry to seek permission from the one or more beacon servers to change its physical location to some other (but again randomly selected) location. In another embodiment, the shadow server may request the associated one or more beacon servers to select a random server location, where the shadow server can move its state and data.

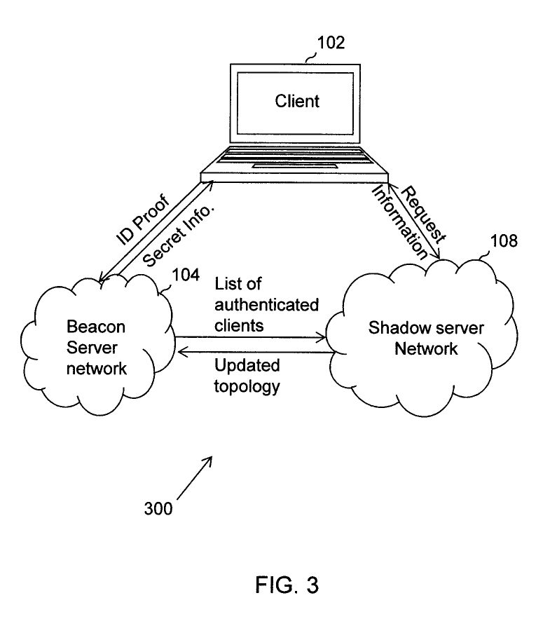

FIG. 3 illustrates another exemplary environment 300 where various embodiments of the present invention are implemented. In an embodiment, the client 102 may connect to Internet and may try to open a website that provides a particular type of service by entering its URL (universal resource locator). During the loading of the website, a beacon server (that is present in the beacon server network) of the website may request the client 102 to authenticate itself by providing necessary credentials i.e. the beacon server may provide a prompt to the client 102 requesting for its validating ID proof or any other key for the purpose of its authentication. In an embodiment, only pre-registered clients can be allowed to avail the services offered by the website.

Thereafter, the client 102 may provide the key (pre-stored with the client 102) to the beacon server. The beacon server may then authenticate the user by matching its data with the pre-existing data of to the legitimate clients. If the data matches, the beacon server may provide certain secret information to the client 102. The secret information may include, but is not restricted to, updated topology of the network from which the client 102 may retrieve contact details of the required shadow server that provides required service(s). In addition, the beacon server may update the shadow server network 108 with the list of authenticated clients.

Further, the client 102 may use the retrieved information corresponding to the required shadow server and may send the information to the website via suitable means. The website may retrieve required information from the respective shadow server and may display the information to the client 102. The client 102 may then provide a response or a query to the website to be communicated to the shadow server. The website may then pass on the response or the query to the shadow server and the shadow server may then accordingly reply. This two way communication between the client 102 and the shadow server via the website may continue unless the shadow server decides to move to a new random location.

Furthermore, the shadow server may decide to move to a new randomly selected place based on the heavy load on its website that may be an indication of an illegal attack on the server. Therefore, the server may decide to change its position to a randomly selected location. In an embodiment, the random location may be selected by a random life algorithm used by the server. The purpose of the random life algorithm may be to maintain complete randomness in selecting a new location for the server. Again further, the shadow server may always inform the respective beacon server corresponding to the decision of moving to a new location. The beacon server may then analyze the load on the shadow server, load on the selected new location, and presence of other shadow servers in the network to determine if any shadow server is present in proximity to the selected location.

Based on the aforementioned, the beacon server may either allow or deny the shadow server to move to the newly selected location. If the beacon server allows the shadow server to move, then the shadow server may replicate its state and data to the server present at the newly determined place. Also, the shadow server may communicate the updated topology to the beacon server network and to the connected clients. The clients may then start following the server at its new location via the website.

In case, if the client does not get any update corresponding to the change of the topology then the client 102 may again approach the beacon server via the website to re-register itself and to receive the updated topology. However, the illegal clients or the false clients those were trying to attack the server with the false requests may never be updated of the new location of the shadow server and may continue to bombard the old location of the shadow server with the malicious requests or queries. This ensures that the shadow servers present in the shadow server network may never get overwhelmed with the malicious attacks and may keep on providing optimum quality of services to its legitimate clients.

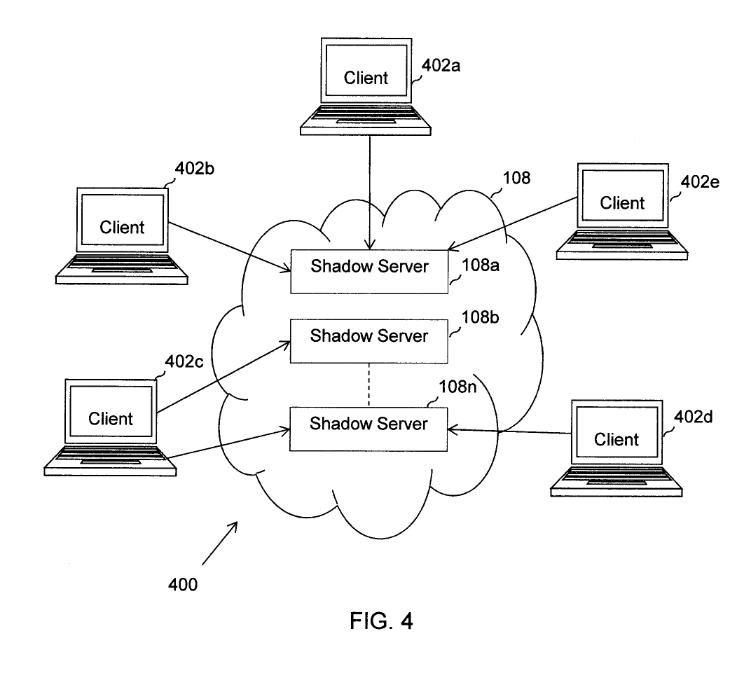

FIG. 4 illustrates yet another environment 400 where various embodiments of the present invention may be implemented. As shown, a number of clients are illustrated to be in communication with the shadow server network 108. The shadow server network 108 may have ‘n’ number of shadow servers and each shadow server may be providing service(s) to more than one clients. Every shadow network may have a list of authenticated clients by one or more beacon servers (as explained previously in conjunction with FIGS. 1 and 3). Moreover, every client may have the contact details of its associated shadow server. The shadow servers may receive requests or queries from the multiple clients 402a, 402b . . . 402e. Moreover, to ensure reliability, the beacon servers may itself form a shadow network via a recursive random system, where the shadow network servers may by themselves be clients to the beacon shadow network. In this case, the shadow servers that act like clients may follow the same rules and interfaces as their own clients. Thus, a recursive notion i.e. a recursive shadow network, for the shadow network can be formed.

As shown, shadow server 108a is requested to provide services by the clients 402a, 402b, and 402e. This shows the load on the shadow server 108a. In case, if a shadow server cannot handle more than two clients then the shadow server 108a can be considered as overloaded. Therefore, the random life algorithm of the shadow server 108a may instruct the shadow server 108a to replicate itself to a new location. In case, if all the clients of the shadow server 108a are authenticated then the movement of the shadow server may not be of much help to the shadow server 108a. In such cases, the shadow server 108a may create a replica of itself at a random location and may steer half of its load to be handled by its replica. In this manner the shadow servers may handle the real load also in such way that the services being provided to the authenticated clients do not get hindered.

Further, the shadow server 108b is requested to provide services by the client 402c only. Additionally, the client 402c has also asked for services to shadow server 108n. It may be a case that the server 108b and 108n both provides same set of services, i.e. a service may be too big to be handled by a single shadow server. Therefore in such cases, if there is an attack on one of the aforementioned server, then the other server may still be running. It may be very hard to attack on both of the servers providing same service, simultaneously, as the shadow servers changes their locations constantly in a random pattern. Hence, only the legitimate clients, such as client 402c, in the aforementioned case may be notified of the actual location of the respective shadow server(s).

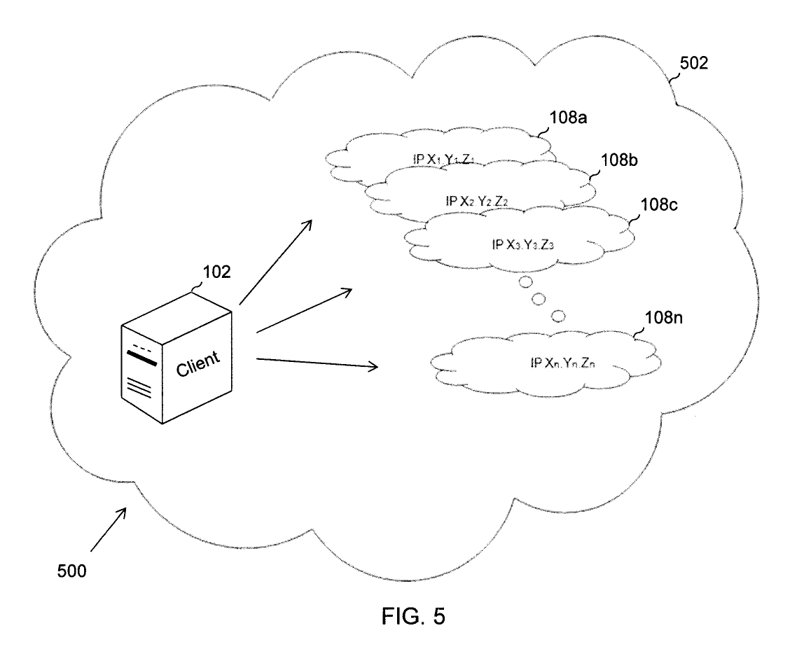

FIG. 5 illustrates still another environment 500 where various embodiments of the present invention may be implemented. The environment 500 includes a series of shadow servers 108a, 108b . . . 108n distributed randomly amongst multiple IP subnets across the entire World Wide Web 502. In an embodiment, the shadow servers 108a, 108b . . . 108n may all be a part of a single organization, such as client 102 and thus may be providing services only for the client 102.

Further, the World Wide Web can be considered as a virtual server or a cloud for the shadow servers. In the cloud of the shadow servers, both of the physical location as well as the logical location of the shadow servers may be constantly changing. These shadow servers may be moved, purged and created at a certain rate that may also be random. Therefore, there may be cases where two or more than two shadow servers may migrate into proximate locations with each other. In such cases, those shadow servers must migrate to other locations.

In an embodiment, the shadow servers may constantly keep a track of the network load present on them. When one or more of the shadow servers (providing similar service) perceive high load, then their random life algorithm may decide to move one or both of them to a new location. The purpose of the random life algorithm is just to maintain randomness in determining new locations to move their respective servers.

Further, the random life algorithm may also search for the location of the other shadow servers on the shadow server network to determine if they are too close in distance with others or not. If the random life algorithm determines that the shadow servers are present in proximate location then the random life algorithms of the associated shadow server may instruct the server to move to a new but randomly selected location. The reason to move the shadow servers physically in the cloud 502 is just to increase randomness in the contact details of the shadow servers, as it is hard to change main logical subnets in a network.

Moreover, the movement to new location may include replication of state and data of a server to another server that is present at another location and is not being used for any purpose. The replication of data enables the new server to function equally as of the old server with just a change in its logical (IP address) and physical location (MAC address).

Therefore, any client who knows the communication address of a server may communicate with the server even if the server changes its location and communication address in between a communication session. The important catch in the invention is that only legitimate clients will be communicated about the new location address of the moving servers, therefore the false/fake/malicious clients will never know that the server has migrated to a new location. Hence, the malicious clients will keep on bombarding on the old node of the server and the actual server will be providing services to its legitimate clients from a different location.

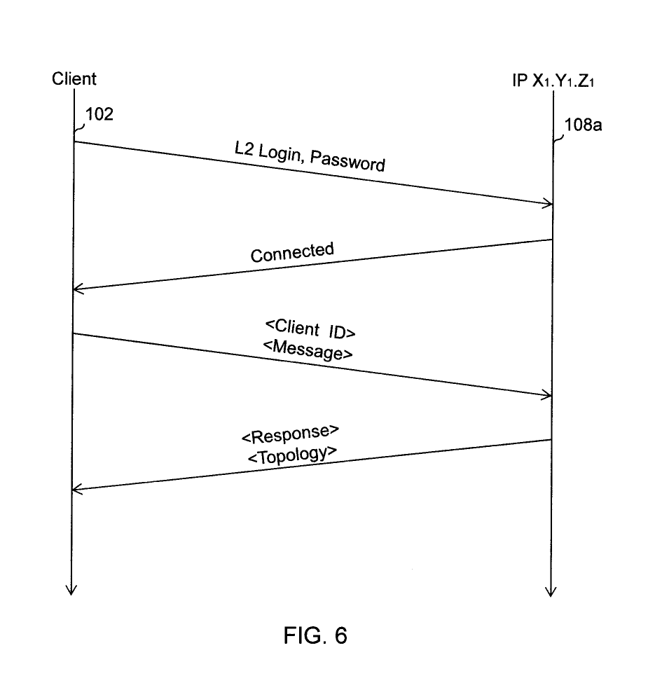

FIG. 6 illustrates a communication structure between a client 102 and a shadow server 108a, in accordance with an embodiment of the invention. The shadow server 108a has a logical IP address X1.Y1.Z1. In an embodiment, if the client 102 requests for a service for the first time, then the client is required to contact a specific location that is predetermined for the client 102. Such location may be an address of a beacon server. The beacon server may be configured to validate the client and to provide it with the current state of the topology that include communication addresses of all the shadow servers and beacon servers.

In a general scenario, communication address of the client 102 is expected to be constant as the beacon server may only identify a client by its communication address. In case, if a client changes its communication address then the shadow servers may not recognize the client and may deny service access to the client. In such scenario, the client must register and validate itself again from a beacon server. After validation, the beacon server may communicate the details of the client to all the shadow servers in order to recognize the client.

Further, if any of the shadow server changes its communication address then the server may also inform the client for the same. In simple words, if a client is constantly in communication with a shadow server then the client will always remain updated about the constantly changing topology of the network, since the rate of transition of the topology may always remain lower than the client's service rate. In an embodiment, respective beacon servers may update their clients corresponding to the change in topology. In case, if a client is having a slow connection to Internet then the client may receive a push message corresponding to the change of topology, either from the beacon server or from the shadow server.

As shown, after the authentication of the client 102 by a beacon server (not shown), the client 102 sends its login ID and password to the shadow server 108a. The shadow server 108a may analyze the credentials provided by the client 102 and may match it with the list of clients that are authenticated by one or more beacon servers. If the credentials provided by the client 102 matches, the shadow server 108a establishes a connection with the client 102. The client 102 then sends a message along with its ‘ID’ to the shadow server 108a. The message may comprise either a request or a query for the shadow server corresponding to the service provided by the server. The shadow server 108a may then analyze the query or request and may provide required response to the client 102.

In an embodiment, if the shadow server planned to migrate from its initial/first/old location to a secret final/second/new location then the shadow server 108a may send the updated network topology to the valid client 102 so that only valid/authenticated clients can communicate with the active server 108a even after the migration to the final/second/new location. In an embodiment, if the client 102 missed the information from the active server, then the client 102 may contact the beacon server to receive the network topology corresponding to an active shadow server, i.e. the network topology may include communication method/address of the active shadow server that is present at the new location. The network topology may enable the client 102 to establish communication with the shadow.

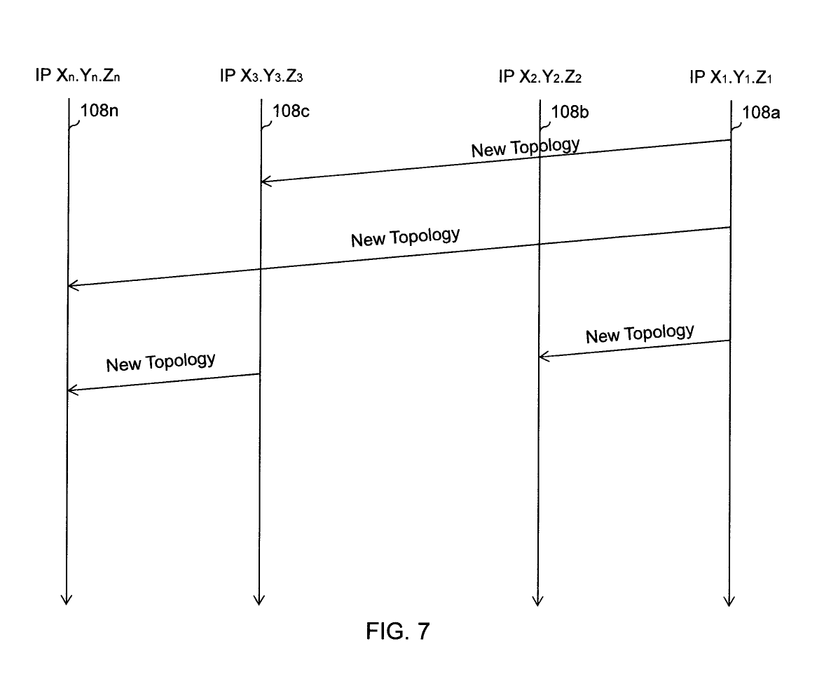

FIG. 7 illustrates structure of the shadow server's migration topology, in accordance with an embodiment of the invention. During server migration, only active shadow servers can choose (based on their random life algorithms) a new location to move or migrate. In an embodiment, beacon servers may also instruct the servers to move to certain location. For migration, the shadow servers copy themselves along with their related state and data into the new location (into an inactive server present at the new location) that is a secret location unknown to anyone present in the network topology, though the server itself informs its valid clients and beacon servers corresponding to its secret new (second) location. After complete migration, the shadow server deletes its data from its previous (first) location and makes that server inactive. Additionally, the shadow server starts functioning from the new location as active server and notifies the respective beacon server for the same.

Further, the beacon server can make its decision of whether or not to allow the migration of the shadow server, based on how close the shadow server is with its neighbor shadow servers, what is the expected network load on its sub-network, and a second set of random parameters. The random parameters may be any naturally or constantly changing event or entity, such as, but is not restricted to, time of the day. For example, the servers may be instructed by the beacon server to migrate to a new location after a prefixed time interval. The time intervals may vary from seconds to centuries depending on the network or server condition. If the beacon server allowed the migration then the server may be assigned with new or old set of clients. Moreover, the clients may also be notified corresponding to the new communication address of their shadow server for communication purposes. In an embodiment, clients may have multiple possible servers to communicate to, therefore the beacon servers may allocate shadow servers to the clients based on the network loads and locations.

Furthermore, as shown in the figure, after migration by the shadow server 108a with IP address X1.Y1.Z1, the shadow server 108a is communicating the updated network topology with the new migration to all other shadow servers present in the shadow server network, such as to shadow server 108b, 108c . . . 108n. In an embodiment, other shadow servers (such as server 108c, as shown) may also update the rest of the shadow servers present in the network corresponding to the updation of the network topology. Similarly, on migration of a shadow server, the server may update other shadow servers present in the network corresponding to the updated network topology.

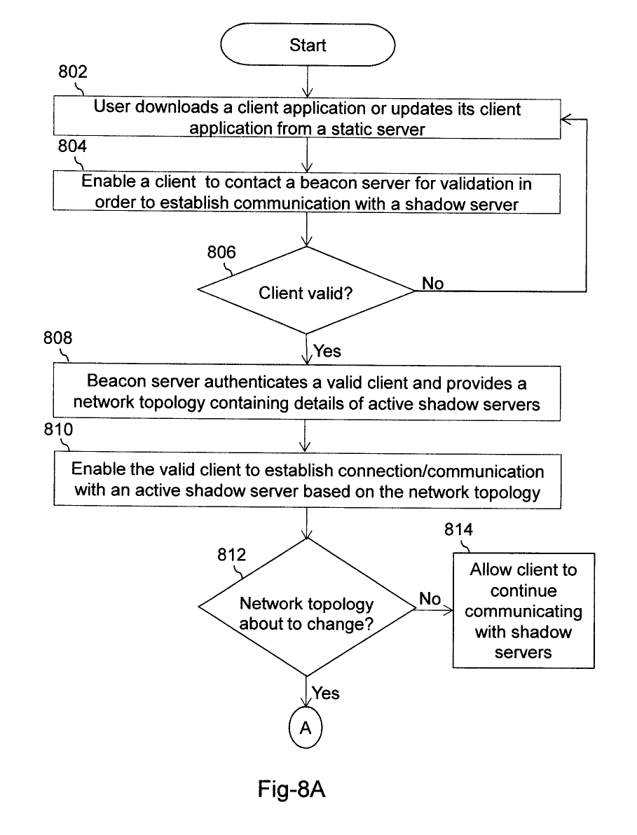

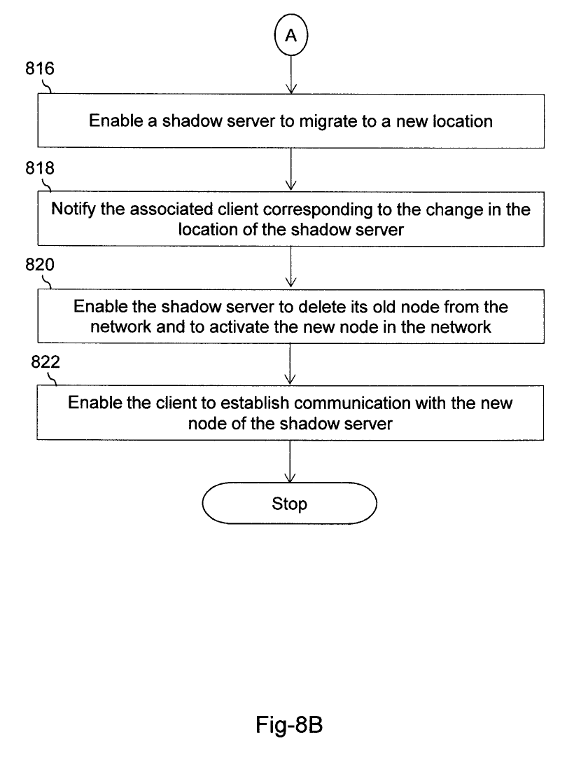

FIG. 8 illustrates a flow diagram of a method for enabling a server present at first location in the network to migrate to second location in the network, in accordance with an embodiment of the invention. At step 802, in order to access a service, a client (user), such as client 102 (as shown in FIG. 1) may contact a static server, such as a web server or a website. In an embodiment, the static server may be the master server 106. The static server may facilitate the client to download or update (if already downloaded) a ‘client application’. The client application may correspond to, but is not restricted to, a software application, an algorithm, a set of instructions or data etc. In an embodiment, the algorithm may be the life algorithm in encrypted form. Further, the client application may include contact details of one or more beacon servers. In an embodiment, the client application may only be downloaded by the users that are registered with the static server. If a registered client approaches the static server then the client may first need to download the client application. However, if the client has already downloaded the client application and is still not able to contact beacon server, then the client may need to update its application. The update may be required in case if the beacon server changes its geographical location in the network by following the life algorithm as followed by the shadow servers.

At step 804, the client may be enabled to communicate with one of the beacon servers, such as beacon server 104a, in order to establish communication with a shadow server, such as shadow server 108a, for enjoying one or more services provided by the shadow server. The beacon server may first check validation of the client to ensure that the services will be provided to a legitimate client only. During the validation, the beacon server may contact the static sever to match details of the client with the information corresponding to clients registered by the static server. Thereafter, at step 806, the beacon server ensures the authenticity/validation of the client by prompting the client to provide valid identification proof. In case, if the client is not found as a valid or legal client then the beacon server may restrict the client to communicate further. The client may then be required to re-validate itself by following the method steps from step 802. In case, if the client is found as genuine or legal then the method may proceed forward to step 808.

At step 808, the beacon server certifies the client as valid/authenticated/legal client/entity and provides a network topology to the client that contains details of active shadow servers and the services offered by them. In an embodiment, after validation of the client, the beacon server may provide an access to the life algorithm (used by the shadow servers) to the client. This may enable the client to communicate directly with any shadow server without being in communication with beacon servers. The life algorithm may enable the client to determine contact details of shadow server at any time period. This may enable the client to seamlessly access services from any shadow server. In case, if the client gets disconnected from the network, the client may lose the access to the life algorithm. Therefore, the client may then need to re-authenticate themselves from beacon servers to get access to the life algorithm used by the shadow servers. Further, at step 810, the beacon server may allow the client to contact one or more of the required shadow servers and create a communication session with them. In an embodiment, the client may be able to decide which shadow server to choose from based on the network topology received from the beacon server.

At step 812, the beacon server may determine whether or not the network topology is about to change or not. In an embodiment, the beacon server may get such information from the shadow servers, as the shadow servers are configured to inform the beacon server(s) before migrating themselves to a new location. Therefore, the beacon servers may stop the shadow servers to migrate, if required. In case, if the shadow servers are configured not to inform the beacon servers corresponding to their new locations (for security purpose), then the beacon servers may use the life algorithm to determine the locations of the shadow servers at a particular time period. Further, if the beacon server determines that the network topology is not going to change (i.e. no shadow server reported any migration planning) then at step 814, the beacon server may allow the client to continue its communication with the shadow server(s). Otherwise, the method may step forward to step 816.

At step 816, the shadow server may replicate its current state and data into a predetermined inactive server present at a new/different/second location/subnet. In an embodiment, the other server may not be new and may be just in inactive state. Further, at step 818, either of the shadow server or the beacon server may contact the client and may communicate the new contact details of the shadow server present at the new/second location. Furthermore, at step 820, the shadow server may delete (cease functioning) the address of its old node (present at the first location) from the network topology and may switch the server present at the old (first location) node to inactive state. In addition, the shadow server may resume its functioning/services from the new node (second location) by registering the address of the new node in the network topology and by activating the state of the new server (present at second location). This may happen subsequent to sharing address of the secret second location with the valid clients by the shadow servers.

At step 822, the client may establish communication with the shadow server that is present at the new/second location with different logical and physical address. In an embodiment, the choice of the new location may be based on the results received from a random life algorithm used by the shadow servers. The random life algorithm may be configured to maintain randomness in the selection of new network nodes where a shadow server can migrate. Another function of the random life algorithm may be to make sure that too many shadow servers may never migrate to locations that are in proximity with each other. This may prevent excessive loading of a sub-network.

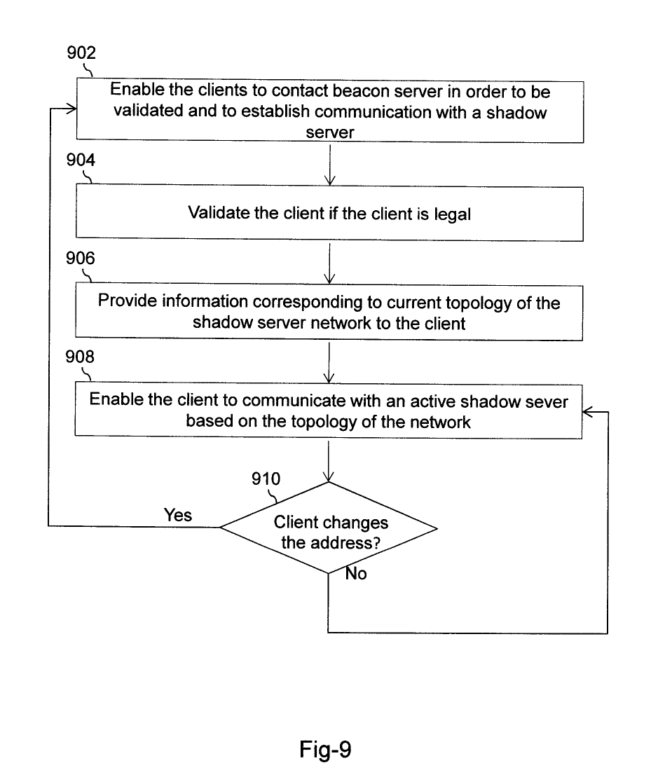

FIG. 9 illustrates a flow diagram of a method for enabling a client to communicate with one or more shadow servers even after changing its address, in accordance with an embodiment of the invention. At step 902, a client is authenticated/validated by a beacon server in order to allow the client to establish communication with a shadow server. The beacon server may demand for the identity proof from the client in order to check if the identity of the client matches with any of the pre-registered/legal clients. In case, if the identity of the client does not matches with any of the legal clients then the beacon server may not allow the client to communicate with any of the shadow servers. Otherwise, the method may step forward to step 904.

At step 904, the beacon server may validate the client after determining that the identity of the client matches with one of the legal clients. Thereafter, at step 906, the beacon server may provide information to the client corresponding to the latest topology of the network. The network topology may allow the clients to identify and locate required shadow servers among the group of many shadow servers. Further, at step 908, the beacon server may allow the client to establish communication session with required set of shadow servers and to enjoy the services offered by the shadow servers.

Further, at step 910, the beacon server may determine if the client has changed its communication address such as, but is not restricted to its physical or logical address. In case, if the beacon server detects that the client has not changed its communication address then the method may start again from the step 908. In another case, if the beacon server detects the client has changed its communication address then the method may start again from the step 902, where the client may re-register itself to get access to the updated topology of the network for communicating with the required set of shadow servers.

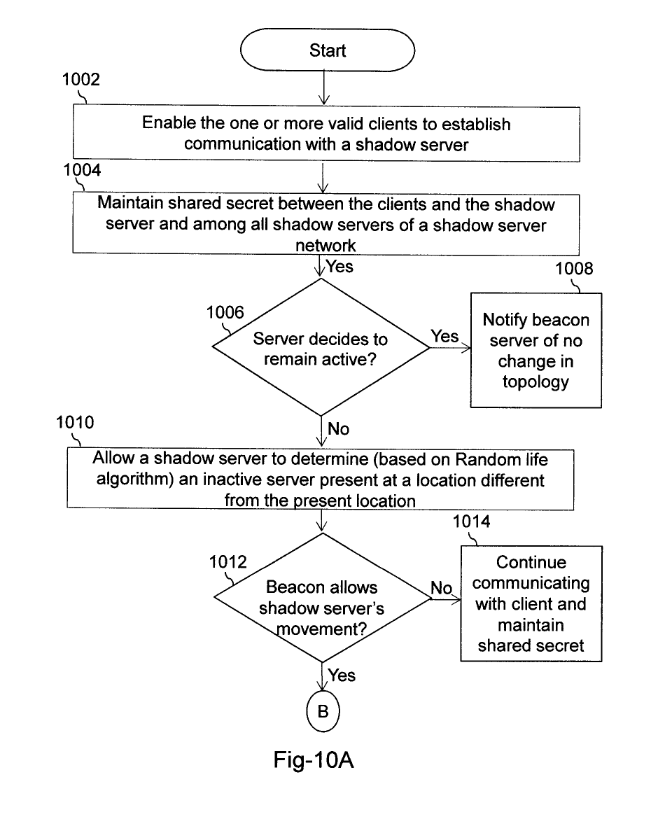

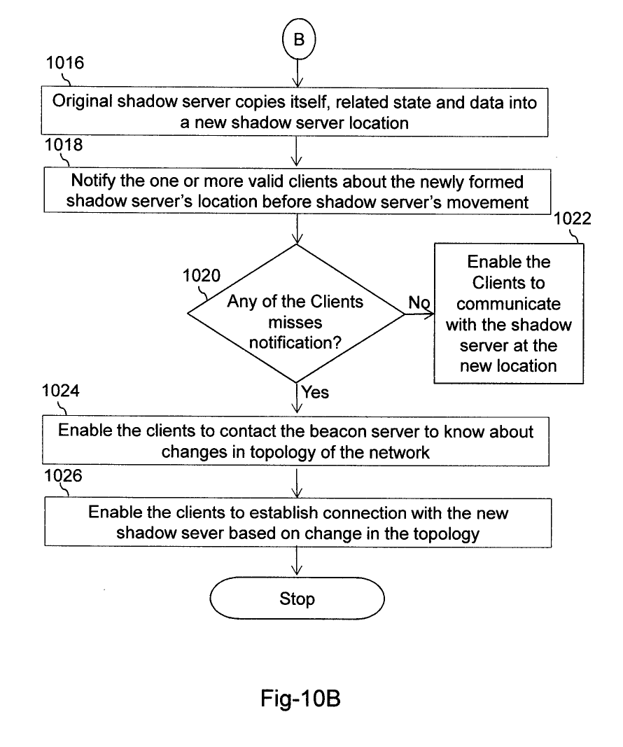

FIG. 10 illustrates a flow diagram of a method for enabling a beacon server to restrict a shadow server from changing its location, in accordance with an embodiment of the invention. At step 1002, the beacon server may authenticate one or more clients requesting to communicate with the shadow servers, and may enable them to communicate with them by providing them updated network topology by which they can figure out the exact shadow server and its corresponding contact details to avail required services.

At step 1004, the beacon server may maintain shared secrets between the clients and the shadow server. The shared secret may correspond to the latest topology of the network that must only be shared with the legal clients. Further, the shared secret may also be shared to the shadow server network among all shadow networks. Therefore, effectively, the share secret, i.e. the network topology must be shared only between the shadow servers and legal clients.

At step 1006, the beacon server may analyze if a shadow server has decided to die (switching of active state to inactive state) or not. A shadow server may decide to die in case if it's random life algorithm instructs the server to move to new place. In case, if the server decided to remain active then at step 1008, the beacon server may get notification that there will not be any change in the network topology. However, if the server decided not to remain active then the method may step forward to step 1010.

At step 1010, the beacon server may allow the shadow server to determine a server that is in inactive state and is present at a location that is different from the current location. In an embodiment, a random life algorithm can be used to determine the new location, as the random life algorithm is configured to ensure randomness in selection of new locations. Further, at step 1012, the beacon server may analyze the determined location where the shadow server will be migrated and estimate the network load at the new location due to the migration of the shadow server. Additionally, the beacon server may analyze the presence of other shadow servers in the proximate areas and accordingly may decide whether or not to allow the shadow server to move to the new location.

In case, if the beacon server analyzes that either network load at the new place will be higher or other shadow servers are operational in the same area then the beacon server may deny the shadow server to migrate to the new location. In another case, if the beacon server analyzes that none of the aforementioned may be there then the beacon server may allow the shadow server to migrate to the new place. Further, at step 1014, if the beacon server denied, then the shadow server may continue providing services to the legal clients from the old location and may continue maintain the shared secret in between. Furthermore, at step 1016, (as shown in FIG. 10B) if the beacon server allowed the shadow server to migrate to new place then the shadow server may replicate its current state and data into the server present at the new location.

At step 1018, before completely migrating to the new location, the beacon server and the shadow server may inform the valid clients (via suitable means) about the new communication address of the shadow server by sharing an updated version of the network topology with a timestamp that may help the valid clients to determine when the shadow server will be completely migrated to its new location.

At step 1020, the beacon server may determine if any of the valid clients has missed the updated version of the network topology. In case, if the beacon server determines that there no valid clients those are not updated with the latest network topology then, at step 1022, the beacon server may allow the clients to communicate with the shadow server present at the new location and enjoy the services offered by the shadow server. Further, at step 1024, if the beacon server detects that one or more clients are not updated with the latest network topologies then the beacon server may allow those clients to re-register/validate themselves with the beacon server to gain the updated version of the network topology. Furthermore, at step 1026, the beacon server may allow the newly registered/validated clients to establish connection the new location of the shadow server according to the new topology and to enjoy services provided by the shadow server from the new location.

Further, the method is not restricted to above information as mentioned herein. The various embodiments that are explained in FIGS. 1-7 may be utilized by each of the methods as explained here above. Further, the invention is not limited to above-mentioned embodiments and examples and many other embodiments and examples may be implemented in light of the invention without departing from the scope of the invention.

It may be appreciated by a person skilled in the art that the present invention is not limited to the above-mentioned embodiments. Further, various other embodiments may also be implemented through the features provided by the system. Also, the usage of terminology such as ‘shadow’, ‘legal’, ‘illegal’, ‘denial of service attack’ should not be considered as restrictive aspect of the present invention as such terminologies are used just for the purpose of better explanation.

Advantageously, the present invention discloses a system and a method to prevent a network of servers from external attacks such as, but is not restricted to, worms and “denial of service” attacks. This enhances the efficiency and reliability on the network of servers. Also, this increases the security level for the network of services. Further, the invention discloses a random life algorithm that can decide lifetime of its associated server at a particular location based on the traffic experienced by the server. This may enable the server to re-born at a random location with only legitimate clients leaving all malicious requests at the previous server node. Furthermore, the system includes a group of beacon servers that are aware of the locations of its associated shadow servers. Every client needs to first validate itself from a beacon server in order to receive latest network topology to determine contact details of the required shadow servers. The beacon servers may also use the life algorithm to protect themselves from being bombarded with malicious service requests.

Once a client gets into communication with its associated shadow server, the client may be automatically updated with the latest network topology, on change of the topology. This way a client can be in continuous communication with its associated shadow server despite of the fact that the topology may change several times in between. Moreover, in case if the client misses any topology change notification from its associated shadow/beacon server, then the client can re-validate itself at its associated beacon server and may receive the updated network topology. Therefore, the current system and method ensures that the shadow servers always remain in communication with its legitimate clients and should always get away from any kind of denial of service attack to ensure smoothness in the delivery of online services.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general purpose computers, special purpose computers, or other programmable data processing translator to produce machines, such that the instructions that execute on the computers or other programmable data processing translator create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims. The invention has been described in the general context of computing devices, phone and computer-executable instructions, such as program modules, being executed by a computer. Generally, program modules include routines, programs, characters, components, data structures, etc., that perform particular tasks or implement particular abstract data types. A person skilled in the art will appreciate that the invention may be practiced with other computer system configurations, including hand-held devices, multiprocessor systems, microprocessor-based or programmable consumer electronics, network PCs, minicomputers, mainframe computers, and the like. Further, the invention may also be practiced in distributed computing worlds where tasks are performed by remote processing devices that are linked through a communications network. In a distributed computing world, program modules may be located in both local and remote memory storage devices.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system for improving security in a network having a plurality of entities therein, the system comprising:
a processor; and
a memory comprising one or more instructions, executable by the processor, for:
providing a network topology corresponding to an active shadow server to a valid entity of the plurality of entities, the network topology being provided to enable the valid entity to establish communication with the shadow server present at a first location,
wherein an address of the shadow server is changed from the first location to a second location based on one or more criteria, and wherein the second location is unknown to the plurality of entities of the network.

2. The system of claim 1, wherein the memory further comprising instructions, executable by the processor, to authenticate the valid entity.

3. The system of claim 1, wherein the memory further comprising a database for storing information corresponding to at least one of the shadow server and each valid entity of the plurality of entities in the network.

4. The system of claim 1, wherein the address of the shadow server is changed by copying corresponding state and data from the first location to the second location, and by deactivating the shadow server at the first location.

5. The system of claim 1, wherein the one or more criteria comprise at least one of:
change in proximity of the shadow server with one or more other shadow servers, in the network, beyond a threshold level;
overloading of the shadow server; and
a set of random parameters.

6. The system of claim 1, wherein the address of the shadow server changes subsequent to informing the valid entity regarding the second location of the shadow server, and wherein the valid entity is informed regarding the second location of the shadow server to enable the communication between the valid entity and the shadow server present at the second location.

7. The system of claim 1, wherein the memory further comprising instructions, executable by the processor, for performing one of:
enabling the valid entity to determine the second location of the shadow server for communicating with the shadow server present at the second location; and
notifying the valid entity and one or more other entities corresponding to the shadow server, regarding the second location of the shadow server.

8. A communication network comprising:
a plurality of shadow servers, each of the shadow servers having a first location assigned thereto, the first location being provided to one or more valid clients for enabling the valid clients to communicate with the shadow server,
wherein the first location of each of the shadow servers changes to a secret second location based on one or more criteria, and wherein the first location changes to the secret second location subsequent to sharing the secret second location with the valid clients of the shadow server.

9. The communication network of claim 8, wherein the valid clients are enabled to communicate with the shadow server subsequent to authentication of the valid clients.

10. The communication network of claim 8 further comprising a data source containing information corresponding to at least one of: the valid clients, the first location associated with the shadow server and the second location associated with the shadow server.

11. The communication network of claim 8, wherein the first location changes to the secret second location by:
transferring state and data, corresponding to the shadow server, from the first location to the second location.

12. The communication network of claim 8, wherein the secret second location is shared with the one or more clients for enabling communication between the clients and the shadow server, when the shadow server is present at the second location.

13. The communication network of claim 8, wherein the one or more criteria comprise at least one of:
change in proximity of the shadow server and one or more other shadow servers, of the plurality of shadow servers, beyond a threshold level;
overloading of the shadow server; and
a set of random parameters.

14. A method for maintaining network security comprising:
determining a distance between a shadow server and one or more other shadow servers to detect proximity there between; and
maintaining a safe logical address distance, between the shadow server and the one or more other shadow servers, by changing an address of the shadow server from a first location to a second location when the proximity between the shadow server and the one or more other shadow servers crosses a threshold level,
wherein the shadow server is enabled to inform one or more valid clients, associated with the shadow server, regarding the second location prior to changing the address of the shadow server from the first location to the second location.

15. The method of claim 14 further comprises authenticating the one or more valid clients to enable communication between the valid clients and the shadow server.

16. The method of claim 14, wherein the address of the shadow server changes from the first location to the second location by transferring the state and data corresponding to the shadow server from the first location to the second location.

17. The method of claim 14, wherein the address of the shadow server is changed from the first location to the second location based on at least one of overloading status of the shadow server and a set of random parameters.

18. The method of claim 14 further comprises performing one of:
enabling the valid clients to determine the second location of the shadow server; and
providing notification to each of the valid clients corresponding to change from the first location to the second location of the shadow server, when address corresponding to the each of the valid clients changes.

19. The method of claim 14, wherein the shadow server informs the valid clients regarding the second location of the shadow server to enable the valid clients to communicate with the shadow server, when the shadow server presents at the second location.

20. The method of claim 14 further comprises storing information corresponding to at least one of the shadow server and the valid clients of the shadow server.
